(19) United States
(12) Patent Application Publication
(10) Pub. No.: US 2011/0244100 A1
(43) Pub. Date: Oct. 6, 2011

(54) METHOD FOR REMOVING WASTE PRODUCTS OBTAINED BY A PROCESS FOR EXTRACTING JUICE, OR PUREE, FROM VEGETABLE OR ANIMAL FOOD, AND APPARATUS THEREFOR

(76) Inventor: Alessandro Bertocchi, Parma (IT)

(21) Appl. No.: 13/131,396

(22) PCT Filed: Dec. 17, 2009
(86) PCT No.: PCT/IB09/07805

§ 371 Date: Jun. 15, 2011

(30) Foreign Application Priority Data
Dec. 17, 2008 (IT) PI2008A000128

(51) Int. Cl. A23N 1/00; A23P 1/00

(52) U.S. Cl. 426/478; 99/511

(57) ABSTRACT

A method for removal of waste material in a process for extracting puree, or juice, from a starting product based on vegetable or animal food comprising a step of feeding a measured amount of starting product to a machine for extracting puree (101). The starting product can be pre-treated, for example softened (102), and then subject to an extraction step (103), obtaining a main product comprising the puree (104), which is discharged via a first outlet (41), and a waste material that is discharged via a second outlet (42) (105). The waste material is then mixed with a measured amount of a liquid, for example water, obtaining a heterogeneous mixture (106). The heterogeneous mixture can be thus easily removed by suction, for example by a hydraulic pump (107) connected to the second outlet, to be quickly withdrawn from the extraction section avoiding the risk of jamming the machine at the second outlet.

### FIELD OF THE INVENTION

The present invention relates to the food industry and, in particular, it relates to a method for removal of waste material, such as peelings, seeds, fibres, etc. during a process for extracting juice and puree from vegetable or animal food.

Furthermore, the invention relates to an apparatus that carries out this method.

### DESCRIPTION OF THE PRIOR ART

As well known, a variety exists of types of rotating machines (milling and finishing machines) for extracting juice or puree mainly from vegetable food, fruit and vegetables, but also from animal food, meat and fish.

Normally, the product to treat is previously softened or chopped more or less finely in a first step for reaching then a second step in an extraction machine where it can also be heated.

The extraction machines of prior art are essentially made up of a fixed structure that comprises a rotary drum sieve of cylindrical or conical shape, so-called sieve, and by an rotor with blades that rotates inside. The rotor is mounted on a shaft and caused to rotate quickly by a motor. In particular, a chopped or softened food product is continuously pushed radially by centrifugal force against the sieve. This way, it is filtered through the sieve holes of the sieve, producing a liquid part (juice) and/or a solid but homogeneous part (puree) that are conveyed away and collected for being then subject to further treatments. The solid parts that do not pass through the sieve, instead, are brought away axially opposite to the inlet and are automatically conveyed to an discharging station that is arranged opposite to the feeding duct. Such waste material is normally caused to leave the machine by the same pressure caused by the rotor within the sieve until they leave the extractor through an opening present on the body of the machine. The waste are then collected and withdrawn by means of conveying systems such as screw conveyors, web conveyors and the like.

However, while the puree flows easily away from the extraction machine by a pump to which it arrives by gravity, the waste have, instead, a difficult evacuation from the machine and a difficult transfer from the machine to a collection area.

The waste, in fact, during the steps of extracting the puree is intentionally as dry as possible, in order to achieve a maximum efficiency of the extraction process, and therefore it is formed mainly by fibres having a low content of humidity.

Furthermore, some types of waste deriving from determined food products have a high content of sugar and are often very viscous and sticky. Therefore, during the step of evacuation from the extraction machine, or within the conveyor ducts, the waste can compact and jam the outlet of the extraction machine, or the ducts downstream of it, as well as the conveyor means.

In case of extraction of puree from an extraction machine that operates under vacuum, the evacuation of the waste has to be carried out by devices that maintain the vacuum within the machine in the critical passage of the waste from the vacuum to an environment pressure. Such evacuation devices can comprise various systems, such as pistons, or rotors, like a variety of types of pumps, but in any case no back passages should be formed through the waste for the air that tends to enter inside from the outer environment. Therefore the evacuation system has to maintain vacuum tight during operation of the machine.

Moreover, all these devices are fed with the waste directly by the rotor of the machine that presses the waste until it falls vertically at the exit from the body of the machine, thus entering an evacuation conveyor; the waste, as above said may stick to the walls which thickens progressively until it is completely obstructed, causing then a block of the machine and different phenomena, such as burning the product by friction as well as jamming the body and the rotor of the machine with waste material.

In addition, the device is designed for products that are more or less homogeneous, but it is not adapted for very viscous and sticky waste, which could spoiling the pistons or rotors of the machine. In fact, the waste material can stick to the surfaces of the device jeopardizing the capacity of the device of transferring it into a collection container.

In U.S. Pat. No. 3,103,438 a method is described for making apple juice. The method provides chopping the apples in the presence of a edible antioxidant substance, for example ascorbic acid, and then forcing it through a narrow passage, comprising the juice, the peelings, the seeds and the other not edible solid parts. The final product is fed through a pump to a first centrifugal device in which the separation is carried out of the apple juice from a secondary product that contains still apple pulp and that is then diluted with water and discharged by gravity into a container. The secondary diluted product is then drawn by a pump and sent to second centrifugal device in which a waste material and an apple puree are separated. In particular, the waste is discharged by gravity from the centrifugal device.

In DE60303503 a method is described to prepare juice of fruit, for example apple juice. The method comprises a first extraction to obtain an intermediate product, preferably without peelings, peduncles and seeds, obtaining juice and a first-extraction waste. To the first-extraction waste, which still contains apple pulp, hot water is added to dissolve the sugar and increasing the sugar content. Then, a secondary product is obtained that is subject to a second extraction obtaining juice and second extraction waste. The first and second extraction juices are, then mixed obtaining the final product.

DE3817689 describes a method to obtain fruit juice by the steps of pressing the fruit and centrifuging it continuously up to an intermediate product with separation of a solid fraction and a liquid fraction. In the intermediate product a foam is present that is treated with pectine and then separated mechanically from the liquid fraction. The foam is then treated with oxygen. A separation step is also provided by decantation of the fibrous cellulosic components of the intermediate product. The solid part can be mixed with water and subject to a further centrifugation obtaining a juice and further fibrous cellulosic components.

In all the known systems as above described, juice of fruit are extracted, giving rise to a intermediate waste that contains still pulp and that is then diluted, in order to extract said pulp in the form of puree with maximization of the extraction efficiency.

In any case, the known systems as above described do not deal with the discharge of the final waste material, i.e. the discharge of the solid part at the exit of the second extraction, mainly peelings, peduncles seeds and other hard parts, is carried out slowly and in a completely solid phase, with the risk of jamming the waste discharge mouth with subsequent need of maintenance stops for restoring the correct operative conditions.

This type of problem tends to increase for machines that work in vacuum conditions during the extraction, for minimizing the enzymatic reactions during the extraction, since the discharge push force of the waste towards the outlet mouth is weaker than the machines that work at atmospheric pressure.

### SUMMARY OF THE INVENTION

It is therefore a feature of the present invention to provide a method for removal of waste material, such as peelings, seeds, fibres in a process for extracting puree, that is adapted to assist and speed up the discharge of the waste.

It is another feature of the present invention to provide a method for removal of waste material, such as peelings, seeds, fibres in a process for extracting puree that improves the overall efficiency of the extraction process.

It is also a feature of the present invention to provide such a method that avoids the drawback of similar apparatus of prior art, and, in particular, undesired maintenance stops for cleaning ducts, or transfer devices obstructed by waste material.

It is still a feature of the present invention to provide a method for removal of waste material that is particularly adapted to extraction machines that work under vacuum for minimizing the enzymatic reactions during the extraction.

It is another feature of the present invention to provide an apparatus that achieves the same advantages.

These and other features are accomplished with one exemplary method for removal of waste material in a process for extracting puree, or juice, from vegetable or animal food, said method comprising the steps of:
feeding said vegetable or animal food;
extracting a main product comprising said puree, or juice, from said vegetable or animal food, said extracting step being made through a rotor that works in combination with a sieve that has a plurality of holes, to provide the separation of said food into a main product and into a substantially solid waste material;
discharging the main product that has passed through said holes via a first outlet;
discharging the substantially solid waste material that has not passed through said holes via a second outlet;
   whose main feature is to provide the further steps of:
adding a measured amount of a liquid to said substantially solid waste material downstream of said extracting step and at said second outlet in order to obtain a heterogeneous mixture comprising said waste material and said liquid;
removing by suction said heterogeneous mixture from said second outlet.

Advantageously, the second outlet is a discharge duct and the step of adding a measured amount of a liquid is carried out at a point of the discharge duct.

In particular, the second outlet is a discharge duct and the step of adding a measured amount of a liquid is carried out at a plurality of points along the discharge duct.

Advantageously, the step or removing by suction is effected by a suction pump in communication with said second outlet.

In particular, the extraction step is carried out in a vacuum environment for minimizing the enzymatic reactions.

Advantageously, before the extraction step, the vegetable or animal food is subject to a treating step to obtain a treated product, wherein said treating step is selected from the group comprised of:
a softening step;
a grinding step;
a chopping step;
a sifting step;
a cutting step;
or a combination thereof.

Preferably, the sieve has tubular shape and during the extraction step the main product, comprising the puree and/or the juice, is discharged radially by the sieve through the sieve holes and the first outlet, whereas the waste material moves axially in the rotor up to reaching the second outlet.

In particular, the heterogeneous mixture can be subject to a separation step, for example by centrifugation, for separating the waste material from the liquid. The liquid thus obtained can be in part recirculated for being again mixed to other substantially solid waste material deriving from the extraction step.

According to another aspect of the invention, an apparatus for extracting puree, or juice, from vegetable or animal food, comprises:
a feeding section for feeding the vegetable or animal food;
an extraction section in which a rotor is arranged that works in combination with a sieve that has a plurality of holes in order to separate the food into a main product comprising said puree, or juice, which passes through the sieve, and into a substantially solid waste material which cannot pass through the sieve;
a discharge section comprising:
   a first outlet through which the main product is discharged that has passed through the holes;
   a second outlet through which the substantially solid waste material is discharged that has not passed through the holes;
an adding section for adding a measured amount of a liquid to the substantially solid waste material obtaining a heterogeneous mixture comprising the liquid and the waste material, said adding section being arranged downstream of the extraction section and at the second outlet;
a suction section for removing the heterogeneous mixture at the second outlet, in said suction section a suction means being provided.

Advantageously, the second outlet is in communication with a discharge duct and the adding section comprises at least one nozzle through which the measured amount of liquid is sprayed into discharge duct, and is mixed with the substantially solid waste material creating a heterogeneous mixture.

In particular, the suction means can comprise at least one suction pump in communication with the second outlet.

Advantageously, in the extraction section a determined vacuum is created for minimizing the enzymatic reactions.

Advantageously between the feeding section and the extraction section a treatment section is provided for treating the vegetable or animal food, obtaining a treated product.

For example, the treatment section can be selected from the group comprised of:
a softening section;
a grinding section;
a chopping section;
a sifting section;
a cutting section;
or a combination thereof.

Advantageously, the treatment section is a softening section comprising a rotor operated by a motor and that is adapted to apply, against a stator, a plurality of pulses in quick succession to the starting product.

In particular, the sieve has tubular shape and the first outlet is arranged along a direction that is substantially radial to the sieve, such that the main product is discharged radially to the sieve, and the waste material moves axially in the rotor up to reaching said second outlet.

Advantageously, the second outlet is arranged at the end of the sieve.

Preferably, the liquid is water.

### BRIEF DESCRIPTION OF THE DRAWINGS

The invention will be made clearer with the following description of an exemplary embodiment thereof, exemplifying but not limitative, with reference to the attached drawings in which:

FIG. 1 shows a block diagram of the main steps of the method according to the invention, for removal of waste material during a method for extracting puree from food of vegetable or animal origin;

FIG. 2 diagrammatically shows an apparatus for carrying out the method according to the invention;

FIG. 3 diagrammatically shows a partial cross sectional view of a possible machine that can be used for separating the main product, i.e. the puree, or the juice, from the substantially solid waste material;

FIG. 4 diagrammatically shows an exemplary embodiment of the adding means that adds a liquid to the substantially solid waste material during the extraction step alternative to that of FIG. 2.

### DETAILED DESCRIPTION OF SOME EXEMPLARY EMBODIMENTS

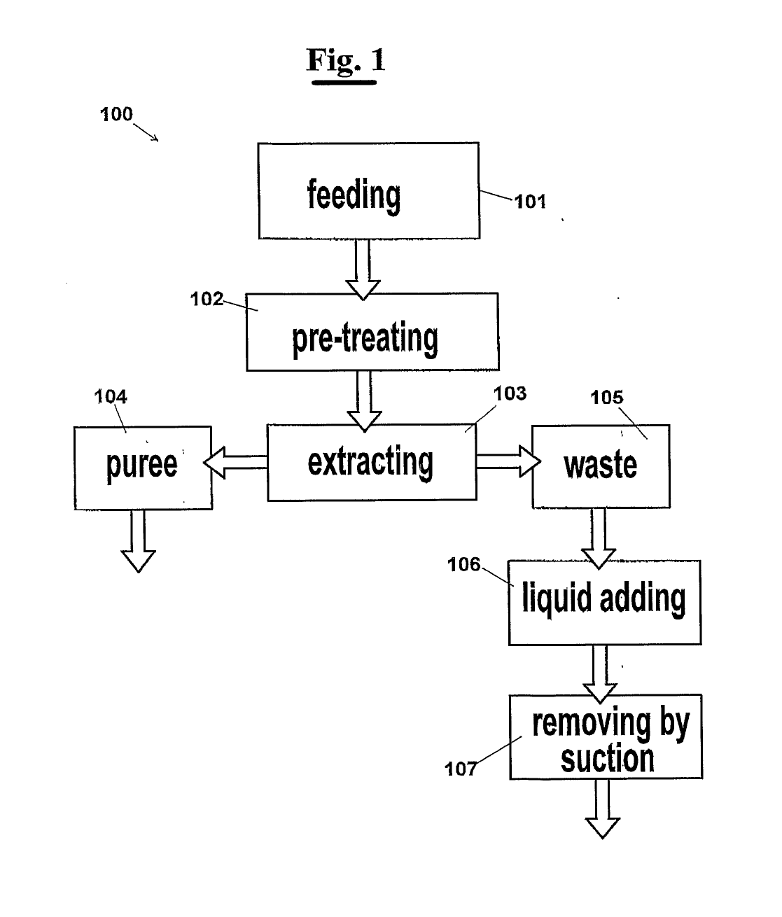

FIG. 1 shows a block diagram 100 of the main steps of the method according to the invention, for removal of waste material in a process for extracting puree, or juice, from a starting product based on vegetable or animal food.

In particular, the method provides a step of feeding a measured amount of starting product to a machine for extracting puree, block 101.

The starting product can be pre-treated, for example softened, block 102, and then subject to an extraction step, block 103, obtaining a main product comprising the puree, block 104, which is discharged via a first outlet and of a waste material that is discharged via a second outlet, block 105.

The waste material is then mixed with a measured amount of a liquid, for example water, obtaining a heterogeneous mixture, block 106. The heterogeneous mixture comprising the liquid and the substantially solid waste material can be then removed by suction, for example by a hydraulic pump, block 107, which is connected to the second outlet, and quickly withdrawn avoiding the risk of jamming the machine at the second outlet.

In an exemplary embodiment of the invention, an apparatus 1, capable of carrying out the method above shown with reference to FIG. 1, provides a feeding section 10 at which the starting product 5 is loaded from a hopper 15. From the feeding section the product can be fed into a treatment section obtaining a treated product. For example, the treatment section can comprise a softening section 20, which is equipped with a rotor 21 and a stator mounted around it. The rotor 21 is, in particular, operated by a motor 80 for applying, in combination with stator 22, a plurality of pulses in quick succession to the starting product. The softened product, at the outlet of the softening section 30, reaches a extraction section 40 where a second rotor, which is operated by the motor 80, engages in a sieve 26 of equal size and arranged in a stator 24, see for example the patent IT1199392.

In the extraction section 40 the second rotor forces the softened product against the surface of the sieve 26 and separates a main product (juice or puree), which is discharged via a first outlet 41, from a substantially solid waste material that comprises peelings, seeds, and other hard fibres, which, instead, are discharged via a second outlet 42.

Downstream of the extraction section 40, furthermore, an adding section 50 is provided at which a measured amount of a liquid, for example water, is added to the waste material, obtaining a heterogeneous liquid/solid mixture.

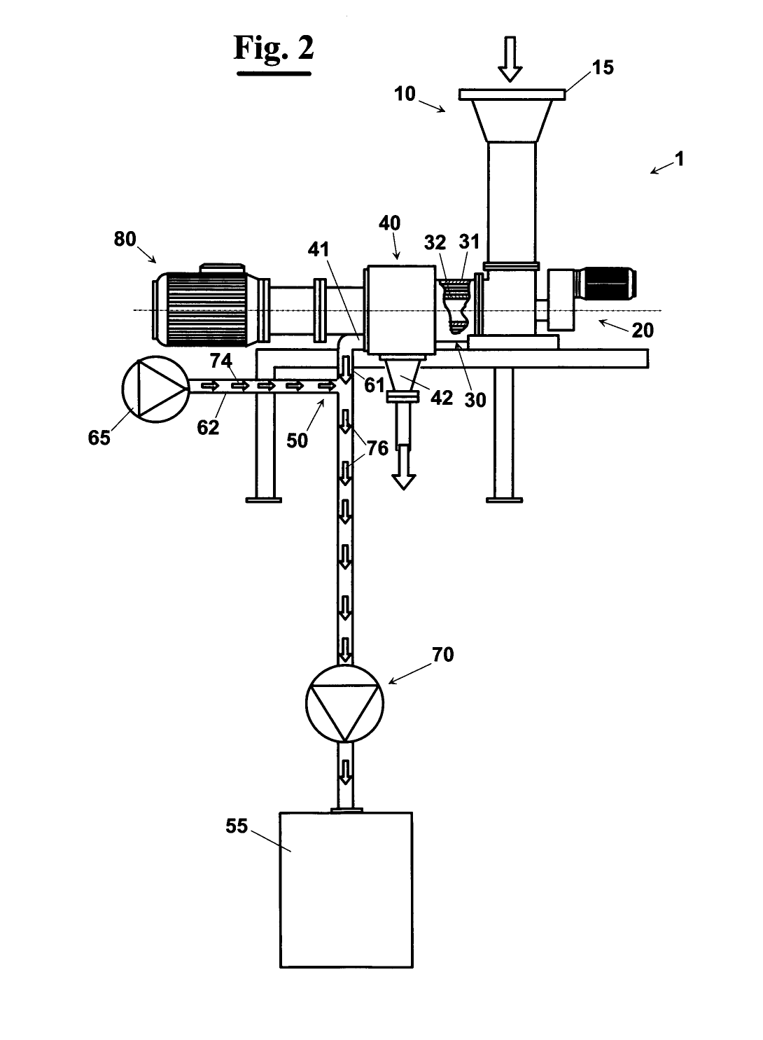

As shown in FIG. 2, the addition of the liquid to the waste material 72 can be made, for example, by a feeding duct 62 for the liquid 74 pushed by a pump 65.

Feeding duct 62 can exit into a discharge duct 61 that connects the second outlet 42 of the extraction section 40 to a storage section 55 in which the waste material 72 is collected. In this case, the liquid 74 is mixed with the waste material 72, to obtain heterogeneous mixture 76, in the discharge duct 61 downstream of the exit point of feeding duct 62.

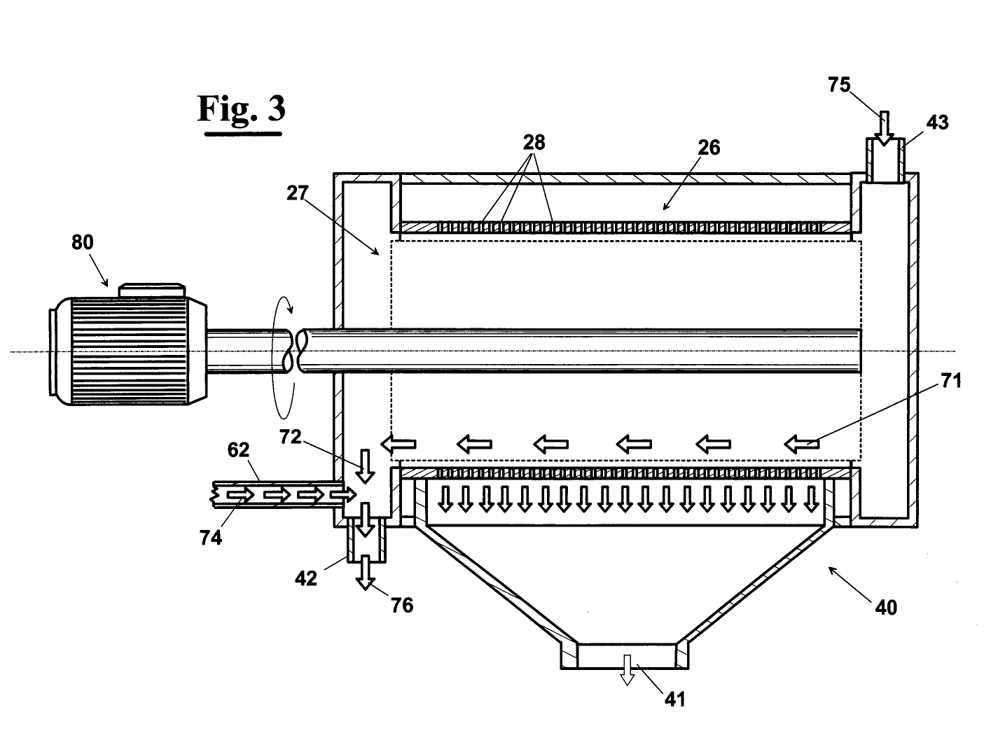

Alternatively, as shown in FIG. 3, the addition of the liquid 74 and its mixing with the waste material 72 can be effected in a zone between the extraction section 40 and second outlet 42.

The waste material 72 that is present in the heterogeneous mixture 76 can be thus easily conveyed away by a pump 70, for example a rotating pump, or a reciprocating pump, into storage section 55. Then, the heterogeneous mixture 76 can be subject to a separation step, for example by centrifugation, for dividing the waste material 72 from the liquid 74.

As shown in FIG. 3, the starting product 75 is inserted through an inlet 43 into extraction section 40, for example of an extraction machine, in which a sieve 26 is present having tubular shape. The sieve 26 has a plurality of holes 28 through which the main product 71 passes through, pushed by the rotor 27, for being then directed towards the first outlet 41, which is arranged radially about the sieve 26. The substantially solid waste material 72, instead, which cannot not pass through the sieve holes 28, moves axially along the extraction section 40 up to reaching outlet 42.

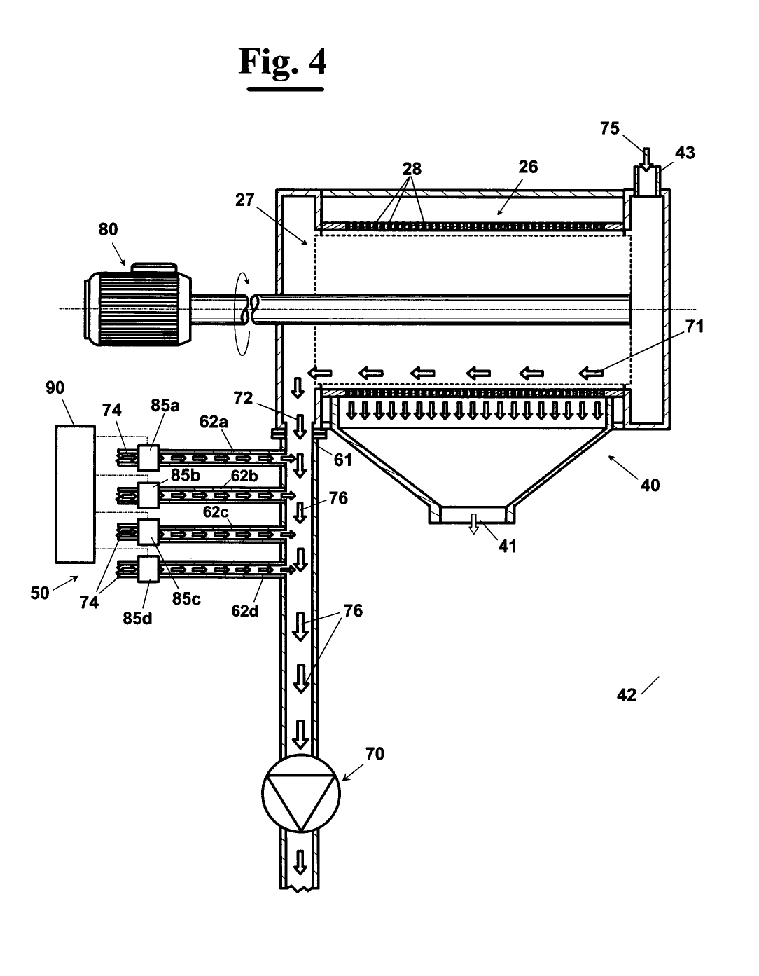

The step of mixing liquid 74 with waste material 72 at the second outlet of the extraction section 40 can be made using several ducts, for example four feeding ducts 62a-62d, exit into discharge duct 61 (FIG. 4). In particular, feeding ducts 62a-62d exit into waste discharge duct 61 at different points. Each feeding duct 62a-62d can be, for example, connected to a respective valve 85a-85d, for example a solenoid valve, which can be closed, or open, independently from each other, by a control unit 90, according to type of process. The liquid 74 once reached discharge duct 61, through at least one feeding duct 62a-62d, is mixed with the substantially solid waste material 72 creating heterogeneous mixture 76 that can be easily removed away by pump 70.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. Method for removal of waste material in a process for extracting puree, or juice, from vegetable or animal food, said method comprising the steps of:
feeding said vegetable or animal food;
extracting a main product comprising said puree, or juice, from said vegetable or animal food, said extracting step being made through a rotor that works in combination with a sieve that has a plurality of holes, to provide the separation of said food into a main product and into a substantially solid waste material;
discharging the main product that has passed through said holes via a first outlet;
discharging the substantially solid waste material that has not passed through said holes via a second outlet;
characterised in that it provides the further steps of:
adding a measured amount of a liquid to said substantially solid waste material downstream of said extracting step and at said second outlet in order to obtain a heterogeneous mixture comprising said waste material and said liquid;
removing by suction said heterogeneous mixture from said second outlet.

2. Method, according to claim 1, wherein said second outlet is a discharge duct and said step of adding a measured amount of a liquid is carried out at a point of said discharge duct.

3. Method, according to claim 1, wherein said second outlet is a discharge duct and said step of adding a measured amount of a liquid is carried out at a plurality of points along said discharge duct.

4. Method, according to claim 1, wherein said step or removing by suction is effected by a suction pump in communication with said second outlet.

5. Method, according to claim 1, wherein said extracting step is carried out in a vacuum environment for minimizing the enzymatic reactions.

6. Method, according to claim 1, wherein before said extracting step said vegetable or animal food is subject to a treating step to obtain a treated product, wherein said treating step is selected from the group comprised of:
a softening step;
a grinding step;
a chopping step;
a sifting step;
a cutting step;
or a combination thereof.

7. Method, according to claim 1, wherein said sieve has tubular shape and during said extracting step said main product, comprising said puree and/or said juice, is discharged radially to said sieve through said holes and said first outlet, whereas said waste material moves axially in said rotor up to reaching said second outlet.

8. Method, according to claim 1, wherein said heterogeneous mixture is subject to a separation step, for example by centrifugation, for dividing said substantially solid waste material from said liquid.

9. Apparatus for extracting puree, or juice, from vegetable or animal food, comprising:
a feeding section for feeding said vegetable or animal food;
an extraction section in which a rotor is arranged that works in combination with a sieve that has a plurality of holes in order to separate said food into a main product comprising said puree, or juice, which passes through said sieve, and into a substantially solid waste material which cannot pass through said sieve;
a discharge section comprising:
a first outlet through which said main product that has passed through said holes is discharged;
a second outlet through which said substantially solid waste material that has not passed through said holes is discharged;
characterized in that of providing, furthermore:
an adding section for adding a measured amount of a liquid to said substantially solid waste material obtaining a heterogeneous mixture comprising said liquid and said waste material, said adding section being arranged downstream of said extracting section and at said second outlet;
a suction section for removing said heterogeneous mixture from said second outlet, in said suction section a suction means being provided.

10. Apparatus, according to claim 9, wherein said second outlet is in communication with a discharge duct and said adding section comprises at least one nozzle through which said measured amount of liquid is sprayed into said discharge duct, and is mixed with said substantially solid waste material creating a heterogeneous mixture.

11. Apparatus, according to claim 9, wherein said suction means comprises at least one suction pump in communication with said second outlet.

12. Apparatus, according to claim 9, where in said extracting section a determined vacuum is created for minimizing the enzymatic reactions.

13. Apparatus, according to claim 9, wherein between said feeding section and said extracting section a treatment section is provided for treating said vegetable or animal food, obtaining a treated product, said treatment section being selected from the group comprised of:
a softening section;
a grinding section;
a chopping section;
a sifting section;
a cutting section;
or a combination thereof.

14. Apparatus, according to claim 13, wherein said treatment section is a softening section comprising a rotor operated by a motor and that is adapted to apply, in combination with a stator, a plurality of pulses in quick succession on said starting product.

15. Apparatus, according to claim 9, wherein said sieve has tubular shape and said first outlet is arranged along a direction that is substantially radial to said sieve, such that said main product is discharged radially to said sieve, said waste material advancing axially in said rotor up to reaching said second outlet arranged at the end of said sieve.

16. Apparatus, according to claim 9, wherein said liquid is water.
